(19) United States
(12) Patent Application Publication
(10) Pub. No.: US 2017/0307647 A1
(43) Pub. Date: Oct. 26, 2017

(54) METHOD AND DEVICE FOR TESTING WIND SPEED

(71) Applicant: Goertek Inc., Weifang City (CN)

(72) Inventor: Wenming Yan, Weifang City (CN)

(73) Assignee: Goertek Inc., Weifang City (CN)

(21) Appl. No.: 15/517,478

(22) PCT Filed: Jun. 29, 2015
(86) PCT No.: PCT/CN2015/082664

§ 371 Date: Apr. 6, 2017

(30) Foreign Application Priority Data
Dec. 12, 2014 (CN) 201410766665.3

(51) Int. Cl. G01P 5/14

(52) U.S. Cl. CPC G01P 5/14

(57) ABSTRACT

Disclosed is a method and device for testing wind speed. The method includes, but is not limited to: measuring a static pressure P₀ of an inner cavity of a pressure hole of a mobile device (S100), wherein the pressure hole being in communication with the outside; aligning the pressure hole to a wind direction and acquiring a total pressure P of the wind (S101); and acquiring a current wind speed according to a corresponding relational expression between a wind speed v and a dynamic pressure P−P₀ (S102). The device includes, but is not limited to, a pressure sensor and a wind speed acquiring unit. The technical solution acquires the current wind speed according to a correspondence between wind speeds and dynamic pressures of wind, may effectively improve the precision of the wind speed testing, and does not cause damage to relevant parts of the mobile device.

### CROSS-REFERENCE TO RELATED APPLICATION

This application is a U.S. National-Stage entry under 35 U.S.C. §371 based on International Application No. PCT/CN2015/082664, filed Jun. 29, 2015, which was published under PCT Article 21(2) and which claims priority to Chinese Application No. 201410766665.3, filed Dec. 12, 2014, which are all hereby incorporated in their entirety by reference.

### TECHNICAL FIELD

This application pertains to the technical field of mobile terminals, and particularly to a method and device for testing wind speed.

### BACKGROUND

In current mobile phones and wearable devices, microphones are usually used as a testing sensor for testing wind speed, the principle of which is to calculate the air flow speed by detecting the vibration frequency of a vibrating diaphragm caused by air. Since the vibrating diaphragm of microphones is thin and highly sensitive, instant high pressure is apt to damage or crush the vibrating diaphragm, and furthermore, dusts in an environment with heavy dusts in air might block the microphone and cause an undesirable calculating precision to the microphone.

In addition, other objects, desirable features and characteristics will become apparent from the subsequent summary and detailed description, and the appended claims, taken in conjunction with the accompanying drawings and this background.

### SUMMARY

The present disclosure provides a method and device for testing wind speed to solve the problems in the prior art that the microphone exhibits a poor precision of wind speed testing and the microphone is apt to damage.

To achieve the above object, the present disclosure employs the following technical solutions:

In one aspect, the present disclosure provides a method for testing wind speed, comprising:
measuring a static pressure P₀ of an inner cavity of a pressure hole of a mobile device; wherein the pressure hole is in communication with the outside, and is a specifically formed opening or an existing designed opening in the mobile device;
aligning the pressure hole to a wind direction and acquiring a total pressure P of the wind; and
acquiring a current wind speed according to a corresponding relational expression between a wind speed v and a dynamic pressure P−P₀.

Preferably, the acquiring a current wind speed according to a corresponding relational expression between a wind speed v and a dynamic pressure P−P₀ comprises:
acquiring the current wind speed according to the formula

$$v = \sqrt{\frac{2 ( P - {P}_{0} )}{ρ}} ,$$

wherein ρ is air density.

Preferably, the method further comprises:
measuring a water vapor pressure e in air and measuring an air temperature T; and calculating the air density ρ according to the formula

$$ρ = \frac{P}{{R}_{B} T} ( 1 - 0.378 e / P ) ,$$

wherein R_{B}=287.05 J·kg⁻¹·K⁻¹ is a gas constant of dry air.

Preferably, the mobile device comprises a mobile phone and a wearable device.

According to the method of the technical solution, first, the static pressure of the inner cavity of the mobile device and the total pressure of the wind are acquired, and the difference between the total pressure of the wind and the static pressure is solved to acquire the dynamic pressure of the wind; and then the current wind speed is acquired according to the correspondence relationship of the wind speed and the dynamic pressure. The technical solution can effectively improve the precision of the wind speed testing, does not cause damage to relevant parts of the mobile device, and is completely different from a method of using a microphone to test the wind speed in the prior art.

In a preferred embodiment, the air density in any environment is calculated by measuring the air temperature and humidity to replace the air density constant at the normal temperature and under the normal pressure, to further improve the precision of the wind speed testing.

In another aspect, the present disclosure provides a device for testing wind speed, comprising:
a pressure sensor disposed in an inner cavity of a pressure hole of the device for testing wind speed, wherein the pressure hole is in communication with the outside, and is a specifically formed opening or an existing designed opening in the mobile device; wherein the pressure sensor is configured to acquire a static pressure P₀ of the inner cavity of the pressure hole, and when the pressure hole is aligned with a wind direction, acquire a total pressure P of the wind; and
a wind speed acquiring unit configured to acquire a current wind speed according to a corresponding relational expression between a wind speed v and a dynamic pressure P−P₀.

Preferably, the wind speed acquiring unit is configured to calculate the current wind speed according to the formula

$$v = \sqrt{\frac{2 ( P - {P}_{0} )}{ρ}} ,$$

wherein ρ is the air density.

Preferably, the device for testing wind speed further comprises:
a humidity sensor configured to measure a water vapor pressure e in air;
a temperature sensor configured to measure an air temperature T; and
an air density acquiring unit configured to calculate the air density ρ according to the formula

$$ρ = \frac{P}{{R}_{B} T} ( 1 - 0.378 e / P ) ,$$

wherein R_{B}=287.05 J·kg⁻¹·K⁻¹ is a gas constant of dry air.

Preferably, the temperature sensor and the humidity sensor are both disposed in the inner cavity of the pressure hole of the device for testing wind speed.

Preferably, the temperature sensor and the pressure sensor are integrated on the same chip; or the temperature sensor, the humidity sensor and the pressure sensor are integrated on the same chip.

Preferably, the device for testing wind speed is disposed in a mobile device, and the mobile device comprises a mobile phone and a wearable device.

According to the device of the technical solution, the pressure sensor measures the total pressure of the wind and the static pressure, and the wind speed acquiring unit acquires the current wind speed according to a correspondence between wind speeds and dynamic pressures of wind. The technical solution can effectively improve the precision of the wind speed testing, does not cause damage to relevant parts of the mobile device, and is completely different from a device of using a microphone to test the wind speed in the prior art.

In a preferred embodiment, the temperature sensor and the humidity sensor are respectively used to measure the air temperature and humidity, and the air density in any environment is calculated according to the air temperature and humidity to replace the air density constant at the normal temperature and under the normal pressure, to further improve the precision of the wind speed testing.

### BRIEF DESCRIPTION OF THE DRAWINGS

The present invention will hereinafter be described in conjunction with the following drawing figures, wherein like numerals denote like elements, and:

FIG. 1 is a flow chart of a method for testing wind speed according to an embodiment of the present disclosure; and

FIG. 2 is a structural schematic view of a device for testing wind speed according to an embodiment of the present disclosure.

### DETAILED DESCRIPTION

The following detailed description is merely exemplary in nature and is not intended to limit the invention or the application and uses of the invention. Furthermore, there is no intention to be bound by any theory presented in the preceding background of the invention or the following detailed description.

Specific embodiments of the present disclosure will be further described in detail with reference to the drawings to make objectives, technical solutions and advantages of the present disclosure more apparent.

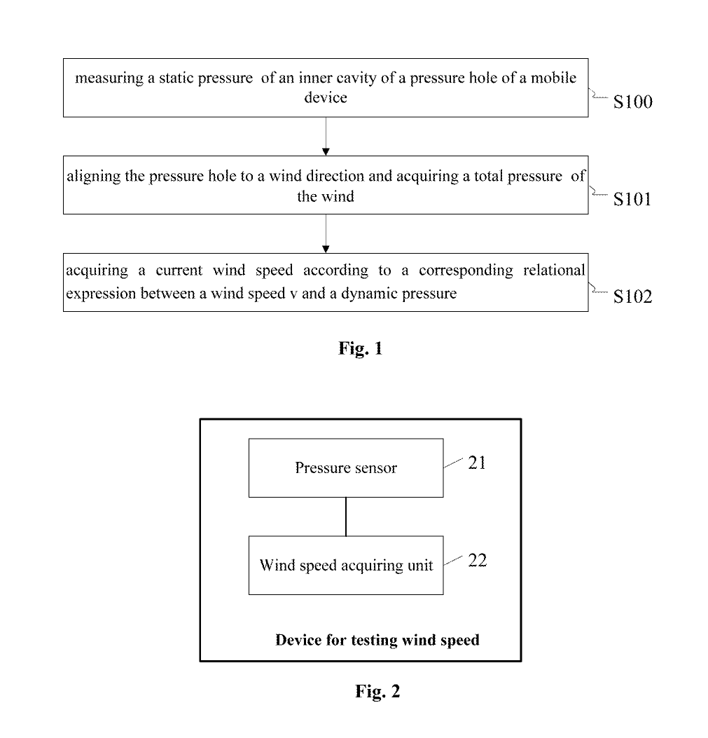

FIG. 1 is a flow chart of a method for testing wind speed according to an embodiment of the present disclosure. The method comprises:

S100: measuring a static pressure P₀ of an inner cavity of a pressure hole of a mobile device, wherein the pressure hole communicates with the outside.

The mobile device may be a mobile phone, a wearable device or the like. Since a too large cross-sectional area of the inner cavity of the pressure hole affects wind resistance and further affects the precision of the wind speed testing, the inner diameter of the inner cavity of the pressure hole of the mobile device is generally set to be about 3.5 mm in practical application, but it is not limited to this. The cross-sectional area of its inner cavity may be specifically set according to the design structure and the application needs of the mobile device.

It needs to be appreciated that the pressure hole may be specifically arranged to match with the design structure of the mobile device, and other openings of the mobile device, e.g., an earphone jack, a power supply hole or other openings connected to the outside, may be used as the pressure hole of the present embodiment to make the appearance of the mobile device simple and beautiful.

S101: aligning the pressure hole to a wind direction and acquiring a total pressure P of the wind.

S102: acquiring a current wind speed according to a corresponding relational expression between a wind speed v and a dynamic pressure P−P₀.

Specifically, the current wind speed is acquired according to the formula

$$v = \sqrt{\frac{2 ( P - {P}_{0} )}{ρ}} ,$$

wherein ρ is air density.

It needs to be appreciated that the air density of the present embodiment may be the air density constant 1.29 kg/m3 in the standard state, or may be the air density constant 1.205 kg/m3 at the normal temperature and under the normal pressure, or may be the air density acquired by other methods in any environment.

In a preferred implementation of the present embodiment, the air density ρ in any environment is acquired by the following method:
measuring a water vapor pressure e in air and measuring an air temperature T; and calculating the air density ρ according to the formula

$$ρ = \frac{P}{{R}_{B} T} ( 1 - 0.378 e / P ) ,$$

wherein R_{B}=287.05 J·kg⁻¹·K⁻¹ is a gas constant of dry air, and P is the total pressure of the wind.

By putting the formula

$$ρ = \frac{P}{{R}_{B} T} ( 1 - 0.378 e / P ) ,$$

into the formula

$$ρ = \frac{P}{{R}_{B} T} ( 1 - 0.378 e / P ) ,$$

another calculation formula for testing the wind speed can be obtained:

$$v = \sqrt{\frac{2 ( P - {P}_{0} )}{\frac{P}{{R}_{B} T} ( 1 - 0.378 e / P )}} .$$

The method of the technical solution of the present embodiment may improve the precision of the wind speed testing by measuring the water vapor pressure e in air and the air temperature T in any environment, and precisely measuring the air density.

FIG. 2 is a structural schematic view of a device for testing wind speed according to an embodiment of the present disclosure. The device for testing wind speed is disposed in a mobile device, and comprises:
a pressure sensor 21 disposed in an inner cavity of a pressure hole of the device for testing wind speed, wherein the pressure hole communicates with the outside, and is specifically disposed on the mobile device or employs an already-existing designed opening;
   wherein the pressure sensor 21 is configured to acquire a static pressure P₀ of the inner cavity of the pressure hole, and when the pressure hole is aligned with a wind direction, acquire a total pressure P of the wind; and
a wind speed acquiring unit 22 configured to acquire a current wind speed according to a corresponding relational expression between a wind speed v and a dynamic pressure P−P₀.

Specifically, the wind speed acquiring unit 22 is configured to calculate the current wind speed according to the formula

$$v = \sqrt{\frac{2 ( P - {P}_{0} )}{ρ}} ,$$

wherein ρ is air density.

It needs to be appreciated that the device for testing wind speed of the present embodiment may be disposed in a mobile device such as a mobile phone, a wearable device or the like.

In a preferred embodiment, the device for testing wind speed of the present embodiment further comprises:
a humidity sensor configured to measure a water vapor pressure e in air;
a temperature sensor configured to measure an air temperature T; and
an air density acquiring unit configured to calculate the air density ρ according to the formula

$$ρ = \frac{P}{{R}_{B} T} ( 1 - 0.378 e / P ) ,$$

wherein R_{B}=287.05 J·kg⁻¹·K⁻¹ is a gas constant of dry air.

Therefore, the wind speed acquiring unit 22 may further calculate the wind speed according to the formula

$$v = \sqrt{\frac{2 ( P - {P}_{0} )}{\frac{P}{{R}_{B} T} ( 1 - 0.378 e / P )}} .$$

Further preferably, the temperature sensor and the humidity sensor of the present embodiment are both disposed in the inner cavity of the pressure hole of the device for testing wind speed, to improve the accuracy of the acquired air density.

Further preferably, the temperature sensor and the pressure sensor of the present embodiment are integrated on the same chip, or the temperature sensor, the humidity sensor and the pressure sensor may be integrated on the same chip, to save physical space and improve the integration degree of the device.

To conclude, the embodiments of the present disclosure provide a method and device for testing wind speed, which comprises acquiring the static pressure of the inner cavity of the mobile device and the total pressure of the wind, solving the difference between the total pressure of the wind and the static pressure to acquire the dynamic pressure of the wind; and then acquiring the current wind speed according to the correspondence relationship of the wind speed and the dynamic pressure. The technical solution can effectively improve the precision of the wind speed testing, does not cause damage to relevant parts of the mobile device, and is completely different from the method of using a microphone to test wind speed in the prior art. Furthermore, in the preferred embodiment, the air density in any environment is calculated by measuring the air temperature and humidity to replace the air density constant at the normal temperature and under the normal pressure, to further improve the precision of the wind speed testing.

While at least one exemplary embodiment has been presented in the foregoing detailed description, it should be appreciated that a vast number of variations exist. It should also be appreciated that the exemplary embodiment or exemplary embodiments are only examples, and are not intended to limit the scope, applicability, or configuration of the invention in any way. Rather, the foregoing detailed description will provide those skilled in the art with a convenient road map for implementing an exemplary embodiment, it being understood that various changes may be made in the function and arrangement of elements described in an exemplary embodiment without departing from the scope of the invention as set forth in the appended claims and their legal equivalents.

1. A method for testing wind speed, wherein the method comprises:
measuring a static pressure P₀ of an inner cavity of a pressure hole of a mobile device, wherein the pressure hole is in communication with the outside, and is a specifically formed opening or an existing designed opening in the mobile device;
aligning the pressure hole to a wind direction and acquiring a total pressure P of the wind; and
acquiring a current wind speed according to a corresponding relational expression between a wind speed v and a dynamic pressure P−P₀.

2. The method for testing wind speed according to claim 1, wherein the acquiring a current wind speed according to a corresponding relational expression between a wind speed v and a dynamic pressure P−P₀ comprises:
acquiring the current wind speed according to the formula
$$v = \sqrt{\frac{2 ( P - {P}_{0} )}{ρ}} ,$$
wherein ρ is air density.

3. The method for testing wind speed according to claim 2, wherein the method further comprises:
measuring a water vapor pressure e in air and measuring an air temperature T; and
calculating the air density ρ according to the formula
$$ρ = \frac{P}{{R}_{B} T} ( 1 - 0.378 e / P ) ,$$
wherein R_{B}=287.05 J·kg⁻¹·K⁻¹ is a gas constant of dry air.

4. The method for testing wind speed according to claim 1, wherein the mobile device comprises a mobile phone and a wearable device.

5. A device for testing wind speed, wherein the device comprises:
a pressure sensor disposed in an inner cavity of a pressure hole of the device for testing wind speed, wherein the pressure hole is in communication with the outside, and is a specifically formed opening or an existing designed opening in the mobile device;
wherein the pressure sensor is configured to acquire a static pressure P₀ of the inner cavity of the pressure hole, and when the pressure hole is aligned with a wind direction, acquire a total pressure P of the wind; and
a wind speed acquiring unit configured to acquire a current wind speed according to a corresponding relational expression between a wind speed v and a dynamic pressure P−P₀.

6. The device for testing wind speed according to claim 5, wherein the wind speed acquiring unit is specifically configured to calculate the current wind speed according to the formula
$$v = \sqrt{\frac{2 ( P - {P}_{0} )}{ρ}} ,$$
wherein ρ is air density.

7. The device for testing wind speed according to claim 6, wherein the device for testing wind speed further comprises:
a humidity sensor configured to measure a water vapor pressure e in air;
a temperature sensor configured to measure an air temperature T; and
an air density acquiring unit configured to calculate the air density ρ according to the formula
$$ρ = \frac{P}{{R}_{B} T} ( 1 - 0.378 e / P ) ,$$
wherein R_{B}=287.05 J·kg⁻¹·K⁻¹ is a gas constant of dry air.

8. The device for testing wind speed according to claim 7, wherein the temperature sensor and the humidity sensor are both disposed in the inner cavity of the pressure hole of the device for testing wind speed.

9. The device for testing wind speed according to claim 7, wherein the temperature sensor and the pressure sensor are integrated on the same chip; or the temperature sensor, the humidity sensor and the pressure sensor are integrated on the same chip.

10. The device for testing wind speed according to claim 5, wherein the device for testing wind speed is disposed in a mobile device, and the mobile device comprises a mobile phone and a wearable device.
